(19) United States
(12) Patent Application Publication
(10) Pub. No.: US 2025/0348346 A1
(43) Pub. Date: Nov. 13, 2025

(54) RESOURCE MANAGEMENT SYSTEM FOR STATELESS MICROSERVICE ARCHITECTURE

(71) Applicants: Fagui LIU, Guangdong Province (CN); Dishi XU, Guangdong Province (CN); Huaiji GAO, Guangdong Province (CN)

(72) Inventors: Fagui LIU, Guangdong Province (CN); Dishi XU, Guangdong Province (CN); Huaiji GAO, Guangdong Province (CN)

(21) Appl. No.: 19/200,688

(22) Filed: May 7, 2025

(30) Foreign Application Priority Data
May 8, 2024 (CN) 202410563596X

(51) Int. Cl. G06F 9/455; G06F 9/50

(52) U.S. Cl. CPC G06F 9/45558; G06F 9/5005

(57) ABSTRACT

A resource management system for a stateless microservice architecture, applicable to a machine cluster running a Linux operating system and a Kubernetes container orchestration platform; the resource management system has a Linux kernel, installed on the machine cluster, for specific system calls; a Microservice Resource Manager for each microservice, installed on a control node of the machine cluster, equipped with a plurality of sub-managers driven to generate buoys indicating a number of Pod replicas in corresponding states based on statistical data; a Coordinator for each microservice, installed on the control node of the machine cluster, for controlling state transitions, creation, and deletion of Pods for a corresponding microservice based on the buoys generated by the plurality of sub-managers; and a Pod Resource Manager, installed on each compute node of the machine cluster, for monitoring state changes of the Pods and executing corresponding Pods resource management operations.

### TECHNICAL FIELD

The present invention relates to the field of cloud computing resource management in computer technology, and more specifically, to a resource management system for a stateless microservice architecture.

### BACKGROUND OF THE INVENTION

The agility, flexibility, and high reliability of cloud computing have propelled the development of a new era where everything is cloud-based, further accelerating the emergence of related concepts and technologies in the field of cloud computing. One of its significant products, cloud-native, aims to maximize the dynamic, elastic, and scalable nature of cloud environments to develop software that can be easily deployed in the cloud, providing stable and reliable network services while leveraging the flexibility of cloud computing to handle fluctuations in request volumes. Containerization and microservice architecture are two key practices of the cloud-native concept. Containers effectively isolate applications into relatively independent spaces without virtualization, offering great convenience for development and deployment. Microservice architecture endows cloud-native applications with excellent extensibility and flexibility. In the deployment of microservice-based applications, using the Kubernetes container orchestration platform to deploy network services has become an industry consensus, and the importance of resource management for containerized network service instances (referred to as Pods in Kubernetes) is increasingly evident.

Due to the simplicity, cross-platform compatibility, and high extensibility of the Java language, a vast number of computer programs worldwide, including those running in containers, are written in Java. However, the characteristics of Java result in a warm-up process for programs written in it—due to the Java Virtual Machine (JVM), Java programs require a certain runtime before reaching peak performance. Therefore, if a container runs a Java program, the container also needs time to achieve its peak performance.

For latency-sensitive network services, it is always the primary goal of existing resource management systems to maximize the utilization of resources such as CPU and memory while maintaining strict end-to-end latency service-level agreements (SLAs). Resource management systems typically improve resource utilization through auto-scaling, i.e., allocating more resources to service instances during high loads and reclaiming excess resources during low loads. However, current auto-scaling solutions struggle to balance service quality and resource overhead.

### BRIEF SUMMARY OF THE INVENTION

It is an object of the present invention to overcome at least one of the aforementioned shortcomings (deficiencies) in the prior art by providing a resource management system for stateless microservice architecture. The resource management system of the present invention can improve the utilization of CPU and memory resources for microservices while ensuring service quality, thereby reducing resource overhead.

The present invention provides the following technical solutions: A resource management system for a stateless microservice architecture, applicable to a machine cluster running a Linux operating system and a Kubernetes container orchestration platform; the resource management system comprises:
a Linux kernel, installed on a machine cluster, for specific system calls;
a Microservice Resource Manager for each microservice, installed on a control node of the machine cluster, equipped with a plurality of sub-managers driven to generate buoys indicating a number of Pod replicas in corresponding states based on statistical data;
a Coordinator for each said microservice, installed on the control node of the machine cluster, responsible for controlling state transitions, creation, and deletion of Pods for a corresponding microservice based on the buoys generated by the plurality of sub-managers;
a Pod Resource Manager, installed on each compute node of the machine cluster, responsible for monitoring state changes of the Pods and executing corresponding Pods resource management operations.

Compared with the prior art, the present invention has the following beneficial effects:
1. By deploying three custom components—a Microservice Resource Manager, a Coordinator, and a Pod Resource Manager—on the control node of a machine cluster, the resource management system implements a combined horizontal and vertical container scaling method, significantly enhancing the resource management capabilities of the Kubernetes container orchestration platform. The resource management system of the present invention improves CPU and memory resources utilization for microservices while ensuring compliance with end-to-end latency Service-Level Agreements (SLAs).
2. In the present invention, a Pod exhibits five states, three of which are newly introduced by the present invention: Warming-up State, L1-Suspended State, and L2-Suspended State. The Warming-up State proactively warms up a corresponding Pod, significantly mitigating the problem of end-to-end latency spikes caused by un-warmed up programs. The L1-Suspended and L2-Suspended states, combined with a tiered resource reclamation strategy, enable different resources recycling (e.g., CPU/memory resources) at varying frequencies, and hence optimizing resources reallocation efficiency.
3. The specific system call in the present invention preemptively swaps all memory pages of a program previously swapped out into the disk back into memory in a single operation. When integrated with predictive swap-in algorithms, the effects of memory swapping mechanisms unto program performance can be effectively reduced.

### BRIEF DESCRIPTION OF THE DRAWINGS

FIG. 1 illustrates distribution of various components of the resource management system of the present invention.

FIG. 2 shows the flowchart for deployment and operation steps of the resource management system of the present invention.

FIG. 3 shows how states can transit from one another in a Pod.

FIG. 4 shows all buoys in relation to different Pod states.

FIG. 5 shows buoy values in relation to Pod states when a microservice is under stable loads.

### DETAILED DESCRIPTION OF THE INVENTION

The drawings of the present invention are for illustrative purposes only and should not be construed as limiting the invention.

### Embodiment 1

This embodiment provides a resource management system for a stateless microservice architecture, applicable to a machine cluster running a Linux operating system and a Kubernetes container orchestration platform. Preferably, it is applied to a machine cluster built on Linux kernel version 3.11 and above and Kubernetes version 1.22 and above. The resource management system controls the state of Pods and further manages available resources of each of the Pods by deploying three custom components—a Microservice Resource Manager, a Coordinator, and a Pod Resource Manager—on a control node of the machine cluster. By introducing different adjustment frequencies and mechanisms for different resource types, the resource management system of the present invention achieves more effective and targeted management of resources such as CPU and memory, significantly improving resources utilization and reducing resource overhead.

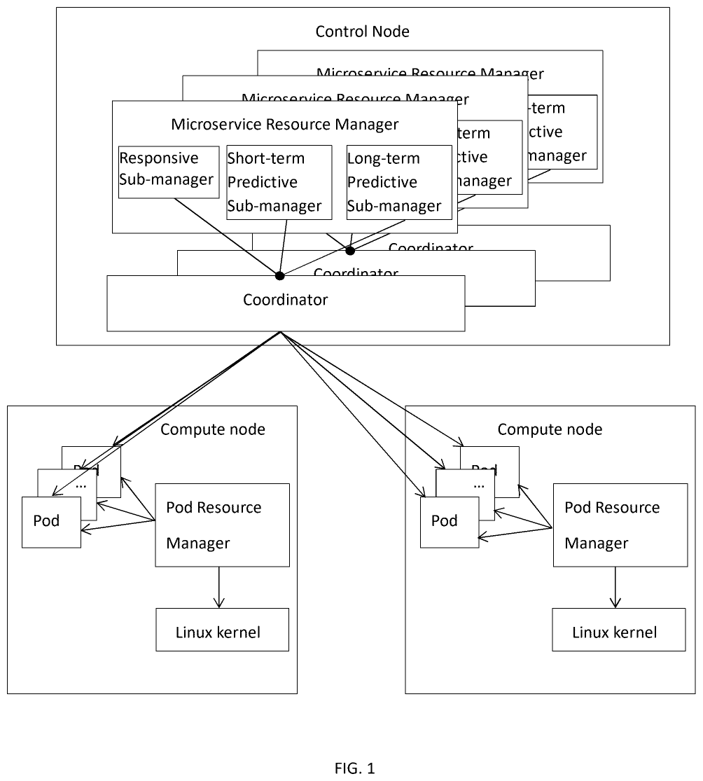

Specifically, as shown in FIG. 1, the resource management system comprises:
a Linux kernel, installed on a machine cluster for specific system calls;
a Microservice Resource Manager, installed on the control node of the machine cluster, equipped with a plurality of sub-managers driven to generate buoys indicating a number of Pod replicas in corresponding states based on statistical data, wherein each microservice has its own Microservice Resource Manager;
a Coordinator, installed on the control node of the machine cluster, responsible for controlling state transitions, creation, and deletion of Pods for a corresponding microservice based on the buoys generated by the sub-managers; wherein each microservice has its own Coordinator;
a Pod Resource Manager, installed on each compute node of the machine cluster, responsible for monitoring state changes of the Pods and executing corresponding Pods resource management operations.

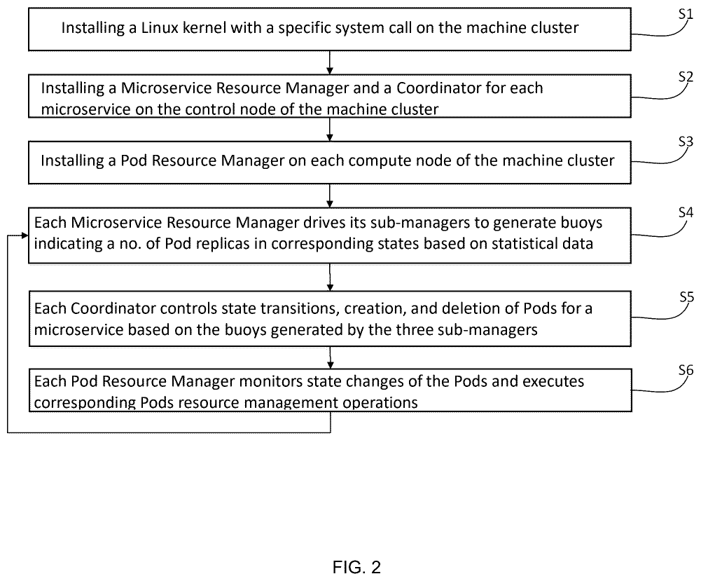

As shown in FIG. 2, deployment and operation of the resource management system comprises the following steps:

S1: Installing a Linux kernel with a specific system call on the machine cluster.

Specifically, in this embodiment, the specific system call is named reload_swappage. The Linux kernel with this specific system call means a new system call is added without altering the original Linux kernel's system calls. This newly added specific system call is used to swap in all memory pages swapped out from a disk during a specific process. The swapped-out memory pages refer to those memory pages temporarily swapped out to the disk using memory swapping technology in a virtual address-based computer system. The swap-in operation reloads these memory pages temporarily swapped out to the disk back into a memory using memory swapping technology. Thus, the specific system call ensures all memory pages temporarily swapped out to the disk during a specific process are reloaded into the memory.

Preferably, this step first obtains the Linux kernel process descriptor using PID, and then uses the shmem_unuse function in Linux kernel code to swap a program's memory pages back into memory.

S2: Installing a Microservice Resource Manager and a Coordinator for each microservice on the control node of the machine cluster.

Specifically, in this embodiment, the control node refers to the Kubernetes container orchestration platform's control node in the machine cluster, which deploys core components of the machine cluster and does not execute microservice computations. The control node only controls the operation of the Kubernetes container orchestration platform itself.

The Microservice Resource Manager is a critical component of the resource management system. As shown in FIG. 1, each Microservice Resource Manager corresponds to a specific microservice deployed in the machine cluster, meaning a number of Microservice Resource Managers equals a number of microservices deployed in the machine cluster. Each Microservice Resource Manager guides a number of Pod replicas in various states for a corresponding microservice. Each Microservice Resource Manager comprises a plurality of sub-managers.

The Coordinator is another critical component of the resource management system. As shown in FIG. 1, each Coordinator corresponds to a specific microservice deployed in the machine cluster, meaning a number of Coordinators equals a number of microservices. Each Coordinator reconciles buoy values generated by the sub-managers of a corresponding Microservice Resource Manager. If the buoy values from the sub-managers do not conflict, the Coordinator directly controls the number of Pod replicas in various states for a corresponding microservice. If conflicts exist, the Coordinator reconciles initial buoy values before adjusting the number of Pod replicas in various states for the corresponding microservice.

S3: Installing a Pod Resource Manager on each compute node of the machine cluster.

Specifically, in this embodiment, each compute node refers to each compute node of the Kubernetes container orchestration platform in the machine cluster, for deploying microservice instances and executes computational logic of the microservice instances.

The Pod Resource Manager is another critical component of the resource management system. As shown in FIG. 1, one Pod Resource Manager is deployed on each compute node, and only one per compute node. The Pod Resource Manager communicates directly with an operating system of the compute node based on Pod states to adjust the available resources (CPU and memory in this embodiment) of a corresponding Pod.

S4: Each Microservice Resource Manager drives the plurality of sub-managers to generate buoys indicating a number of Pod replicas in corresponding states based on statistical data.

S5: Each Coordinator controls state transitions, creation, and deletion of Pods for a corresponding microservice based on the buoys generated by the three sub-managers.

S6: Each Pod Resource Manager monitors state changes of the Pods and executes corresponding Pods resource management operations.

Specifically, in this embodiment, the “state” of a corresponding Pod refers to a label used by the resource management system to indicate a number of requests the corresponding Pod should currently be assigned and an amount of resources the corresponding Pod can use.

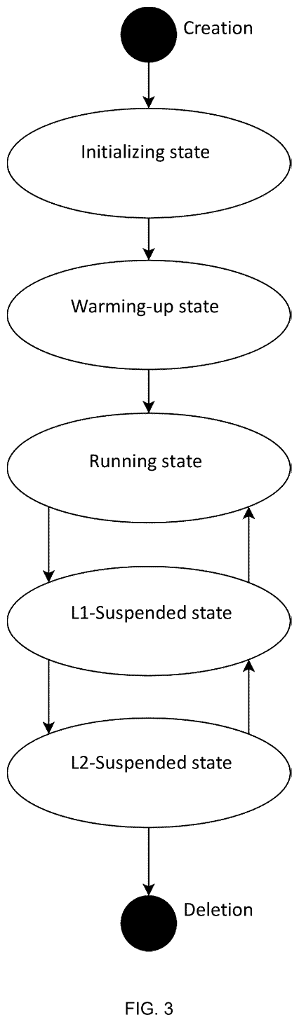

As shown in FIG. 3, each Pod in this embodiment has five states: Initializing state, Warming-up state, Running state, L1-Suspended state, and L2-Suspended state. Specifically, the state labels can be set as Initializing, Warming, Running, L1Suspended, and L2Suspended. The Coordinator identifies each Pod's state by controlling a genesis.io/state label value. States have transition relationships between them, and state transitions must follow these transition relationships.

The transition relationships refer to the rules that must be followed when a Pod changes its state. As shown in FIG. 3, transitions can only occur in according to directions indicated by the arrows. An example of a valid state transition is from the Running state to the L1-Suspended state. Multiple state transitions can occur within one control cycle-for example, a state of a Pod can transition from Running state to L2-Suspended state. An example of an invalid state transition is a transition from Running state back to Warming-up state, as there is no arrow pointing from Running state to Warming-up state in FIG. 3, and so such transition is impossible.

In this embodiment, the control cycle refers to the period from step S4 to S6 where all related components in the resource management system complete one round of operations. In other words, the cycle begins when the Microservice Resource Manager analyzes the statistical data, and ends when the Pod Resource Manager performs resource management (adjustment) operations on each Pod. Each microservice has its own independent control cycle, and execution of the control cycle of a specific microservice is not affected by control cycles of other microservices.

Creation of a Pod refers to Kubernetes container orchestration platform creating a new container instance based on container template.

The Initializing state refers to a state where Kubernetes is performing initialization operations on a newly created Pod. During initialization, Kubernetes performs operations such as assigning IP address, allocating storage volume, and setting environment variables. The Pod in this state cannot execute any business logic of a corresponding mircoservice, so load requests cannot be routed to the Pod under the Initializing state.

The Warming-up state refers to a state where the Pod has completed initialization and can execute a business logic, but hasn't yet reached peak execution speed and response time. This state is common in Java programs. Not all Pods go through this state—Pods that don't require warm-up can skip this state directly. For Pods containing JVMs, they need to run for some time before reaching peak performance, so the Warming-up state represents a period between initialization completion and peak performance.

The Running state refers to a state where the Pod can normally process requests at peak (maximum) speed and peak (fastest) response time. In this resource management system, most load requests are distributed to Pods having this Running state to ensure most requests are processed within a normal range of response time.

The L1-Suspended state is a unique Pod state in this resource management system. A Pod in this state should have its CPU resources partially or entirely reclaimed, wherein an exact amount of CPU resources being reclaimed depends on the Pod's background task status and reclamation operations of a corresponding Pod Resource Manager. Theoretically, a Pod in this state will not accept new requests but will continue processing previously received requests received before the Pod transiting to the L1-Suspended state.

The L2-Suspended state is another unique Pod state in this resource management system. A Pod in this state should have its CPU and memory resources partially or entirely reclaimed, wherein an exact amount of CPU and memory resources being reclaimed depends on the Pod's background task status and reclamation operations of a corresponding Pod Resource Manager. Theoretically, a Pod in this state will not accept new requests but will continue processing previously received requests received before the Pod transiting to the L2-Suspended state.

Deletion of a Pod refers to Kubernetes container orchestration platform removing the Pod from the machine cluster.

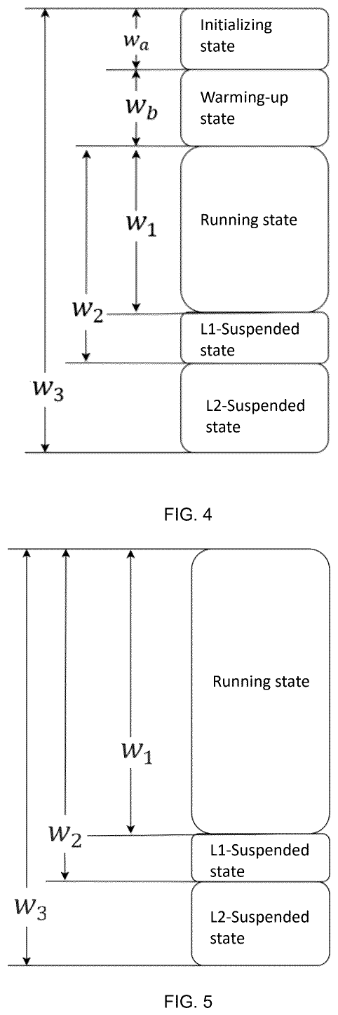

The buoys are used to indicate a sum of containers in various states. The resource management system uses five kinds of buoys: namely first buoy w₁, second buoy w₂, third buoy w₃, fourth buoy wₐ, and fifth buoy w_{b}. The presence and relationships of the buoys with respect to different Pod states are shown in FIG. 4. Under stable loads, quantities of both the fourth buoy wₐ and the fifth buoy w_{b} are zero, meaning that a Pod of a microservice under stable loads only has Running, L1-Suspended, and L2-Suspended states. FIG. 5 shows a relationship between the buoys under stable loads.

In actual implementation, the sub-managers of the Microservice Resource Manager comprises: a Responsive Sub-manager, a Short-term Predictive Sub-manager, and a Long-term Predictive Sub-manager.

The Responsive Sub-manager generates an initial value of first buoy w₁ using responsive methods based on the microservice's past resource usage within a predetermined period. First buoy w₁ represents a number of Pods in the Running state.

The Short-term Predictive Sub-manager uses EnbPI interval prediction and SVR single-step prediction algorithms for short-term forecasting to generate an initial value of second buoy w₂. Second buoy w₂ represents a sum of the number of Pods in Running state and in L1-Suspended state.

The Long-term Predictive Sub-manager uses Prophet periodic prediction, EnbPI interval prediction, and SVR single-step prediction algorithms for long-term forecasting to generate an initial value of third buoy w₃. Third buoy w₃ represents a total number of Pods across all states.

In a preferred embodiment: the Responsive Sub-manager generates the first buoy w₁ every five seconds; the Short-term Predictive Sub-manager generates the second buoy w₂ every one minute; and the Long-term Predictive Sub-manager generates the third buoy w₃ daily. The control cycle adopts the shortest buoy generation interval (which is five seconds).

The fourth buoy wₐ indicates a sum of Pods being initialized and Pods completing initialization but waiting to warm up in a single microservice of the resource management system of the present invention.

When the Long-term Predictive Sub-manager's newly generated third buoy w₃ exceeds current number of Pod replicas, the Coordinator calculates a number Pods need to be created, directs the Kubernetes container orchestration platform to create new Pods, and warms up new containers according to a predetermined ratio.

The fifth buoy w_{b} indicates a number of Pods in the Warming-up state Pods in a single microservice, preventing excessive Warming-up Pods which may otherwise lead to unacceptable excessive end-to-end delays that result in failure to meet service level. The fifth buoy w_{b} is derived according to the fourth buoy wₐ.

In this embodiment, the statistical data refers to multiple metrics that can reflect a current load pressure of a corresponding microservice. Specifically, this embodiment collects the microservice's average CPU utilization rate, average memory usage, and average requests received per minute. The statistical data can be observed directly from the Microservice Resource Manager, and stored using Prometheus and TimescaleDB tools.

The Responsive Sub-manager and the Short-term Predictive Sub-manager follow similar logic when generating the first buoy w₁ and the second buoy w₂ respectively, wherein in both cases, a proportional relationship between a buoy value from a previous time period and a current statistical data is used to determine a current buoy value. This is mathematically described as:

$${w}_{x}^{t + 1} = ⌈ {w}_{x}^{t} * \frac{{M}_{current}}{{M}_{standard}} ⌉ ; \qquad ( 1 )$$

In the above formula (1), wₓ can represent either w₁ or w₂; wₓ^{t} represents a value of buoy wₓ at time t; wₓ^{t+1} represents a value of buoy wₓ at time t+1; M_{current} represents a current value of a certain metric M; M_{standard} represents an ideal value of the metric M.

Here, M_{current} should have a negative correlation with wₓ, meaning that if other variables are unchanged, a larger wₓ will result in a smaller M_{current}. If the selected metric does not have this negative correlation, mathematical transformations should be applied to satisfy this negative correlation.

M_{standard} is the ideal value of the metric M, which is a preset value such as an ideal average CPU utilization value of Pods, or average requests per minute per Pod etc. For different microservices, the value of M_{standard} is usually different, therefore, M_{standard} needs to be manually measured and set. Once set, M_{standard} generally does not need to be adjusted again, but if M_{standard} needs to be changed, it can be readjusted through components.

Both the Responsive Sub-manager and the Short-term Predictive Sub-manager generate corresponding buoy values using formula (1). The difference lies in the different metrics M used by the two sub-managers and the processes and methods for generating M_{current}.

In this embodiment, the Responsive Sub-manager calculates one of the sources of M_{standard} by taking an average of metric changes within a sliding time window and adding a product of a percentile threshold a and a standard deviation, as shown in formula (2):

$${v}_{1} = mean ( {H}_{M}^{m} ) + PPF ( {H}_{M}^{m} , 0.95 ) * stdev ( {H}_{M}^{m} ) ; \qquad ( 2 )$$

The percentile threshold a can be set to 95%; in formula (2),

$$mean ( {H}_{M}^{m} )$$

represents an average of metric sequence M within a time window of size m;

$$PPF ( {H}_{M}^{m} , a )$$

represents the 95^{th} percentile of metric sequence M within a time window of size m;

$$stdev ( {H}_{M}^{m} )$$

represents the standard deviation of metric sequence M within a time window of size m; v₁ is one of the important sources for the Responsive Sub-manager to generate M_{current}. Specifically, in this embodiment, metrics are collected every five seconds, with a time window size m of 60.

$${v}_{2} = max ( {H}_{M}^{n} ) ; \qquad ( 3 )$$

In this embodiment,

$$max ( {H}_{M}^{n} )$$

in formula (3) represents a maximum value of metric sequence M within a time window of size n, and v₂ is another important source for the Responsive Sub-manager to generate M_{current}. In this embodiment, metrics are collected every 5 seconds, with a time window size n being 120.

$${M}_{current} = max ( {v}_{1} , {v}_{2} ) ; \qquad ( 4 )$$

The Responsive Sub-manager's M_{current} is obtained from formulas (2), (3), and (4). By substituting a calculated M_{current} into formula (1), a corresponding buoy value

$${w}_{x}^{t + 1}$$

for the microservice at a next (t+1) time point can be obtained.

The Short-term Predictive Sub-manager uses a combination of interval prediction algorithm EnbPI (Ensemble Batch Prediction Intervals) and single-step prediction algorithm SVR (Support Vector Regression) to generate buoy w₂. EnbPI is an advanced interval prediction algorithm that does not require any assumptions about data distribution of time series, and is therefore suitable for non-stationary time series, and can be paired with various underlying regression algorithms. The underlying regression algorithm chosen for this resource management system is SVR, which is an exemplary regression algorithm based on support vector machines that maps data to a high-dimensional data space through nonlinear mapping, where independent and dependent variables exhibit good linear regression characteristics in this high-dimensional feature space. After fitting in this feature space, the results are mapped back to the original space.

In this embodiment, the Short-term Predictive Sub-manager uses SVR as the underlying regression algorithm for single-step prediction and then uses the EnbPI algorithm for interval prediction. More intuitively, the Short-term Predictive Sub-manager continuously collects V+N observed metrics from a past period as a new set of training data for SVR, for example, V+N=300+12. Here, the first 300 observed metrics form the input values of the training data, and the maximum value of the subsequent 12 observed metrics serves as a label value for this set of training data. This set of data is added to the training data. When a number of training data sets meets the minimum requirement for training sets, an SVR prediction group is obtained in two ways:
\textcircled{1} When the collected training data sets first meet the training requirements, train B new SVR models (e.g., 20 new SVR models) based on the collected training data sets to obtain an initial SVR prediction group.

\textcircled{2} When an SVR prediction group already exists, delete the oldest set of training data and k number of SVR predictors trained with the oldest data in the EnbPI algorithm. Then, train k number of new SVR predictors based on the new training data to keep a number of predictors in the SVR prediction group constant at 20.

In this embodiment, according to an execution method of the EnbPI algorithm, the confidence level α is set to 95%. Using the existing SVR prediction group, a maximum value y within next 12 observed metrics is predicted based on the most recent 300 observed metrics, and ensuring that a probability of the true maximum not exceeding the predicted maximum value y is

$$\frac{1 + 0.95}{2} = 0.975 .$$

The Short-term Predictive Sub-manager uses the maximum value y predicted by the above EnbPI and SVR algorithms as its M_{current} and substitutes this value of the M_{current} into formula (1) to obtain the value of buoy w₂.

The Long-term Predictive Sub-manager uses Prophet algorithm to predict specific metric information for a future cycle based on longer-term cyclical information. The Prophet algorithm is a time series forecasting open source algorithm by Facebook® and is widely used worldwide for its simplicity, efficiency, and minimal parameter tuning requirements.

The cycle is related to actual request loads, with common cycles being daily or weekly, as request volumes tend to exhibit periodic changes over time.

The Long-term Predictive Sub-manager first uses the Prophet algorithm to directly predict a number of Pod replicas required at a next time point based on historical cycle changes of request loads, and thus an initial value of buoy w₃ is obtained. If a value of buoy w₃ generated by the Long-term Predictive Sub-manager is less than a value of buoy w₂ generated by the Short-term Predictive Sub-manager, the combined EnbPI and SVR method described above is used to correct the value of buoy w₃.

More specifically, the resource management system of the present invention uses the combined EnbPI and SVR method with a confidence level β to predict a difference z between buoy w₂ and the initial third buoy w₃. The initial third buoy w₃ plus this predicted value z serves as an initial value of a new third buoy w₃.

The goal of the Long-term Predictive Sub-manager is to generate the smallest possible third buoy w₃ without passively triggering Pod creation operations. In other words, the third buoy w₃ should have a value higher than a true value of a required number of Pods, but should not be excessively overestimated. The reason for allowing the third buoy w₃ to have a value higher than the true value of the required number of Pods is that the resource management system of the present invention has a unique resource-saving mechanism. Even if extra Pods are created, they can be converted to L1-Suspended or L2-Suspended states, thereby saving the over-allocated resources. However, if the third buoy w₃ has a value lower than the true value of the required number of Pods, it will trigger Pod creation operations, which incur significantly higher costs than converting L1-Suspended or L2-Suspended Pods to the Running state. Therefore, it is reasonable in this resource management system to set the value of the third buoy w₃ slightly higher than the true value of the required number of Pods.

Because the operational costs introduced by various operations differ, the three Sub-managers also update their corresponding buoys at different frequencies.

Updating the first buoy w₁ within a reasonable range of time will cause CPU resources to be allocated or reclaimed. Since the overhead introduced by changes of CPU resources is relatively small, the Responsive Sub-manager updates the first buoy w₁ at the highest frequency.

Updating the second buoy w₂ within a reasonable range of time will cause memory resources to be allocated or reclaimed. In this resource management system, the overhead introduced by memory resources reallocation comes from memory pages swapping in and out, which is greater than the overhead of CPU resources allocation and reclamation. Therefore, the Short-term Predictive Sub-manager updates the second buoy w₂ at a lower frequency than the first buoy w₁.

Updating the third buoy w₃ will cause Pods to be created or deleted. Pod creation operations introduce initialization and warm-up overhead, while Pod deletion operations trigger Pod cleanup and resource reclamation, both of which introduce significant operational overhead. To minimize the overhead caused by Pod creation and deletion, the Long-term Predictive Sub-manager updates the third buoy w₃ at the lowest frequency.

According to a specific implementation, the Coordinator determines whether to perform buoy value repair operations based on relative sizes of the initial values of the first buoy w₁, second buoy w₂, and third buoy w₃, as follows:

Under normal circumstances, the relative sizes of the three buoy values satisfy w₁≤w₂≤w₃.

Under abnormal circumstances, when the relative sizes of the three buoy values do not satisfy w₁≤w₂≤w₃, the Coordinator corrects the values of each buoy to satisfy a normal relative size relationship.

Given that w₁≤w₂≤w₃ is satisfied, the Coordinator adjusts the states of the corresponding Pods according to a state transition logic, hence ensuring that the number of Pod replicas of each Pod state matches the corresponding buoy value(s).

The Coordinator correct the values of each buoy to satisfy the normal relative size relationship according to the following logic:

Let

$${w}_{1}^{t} , {w}_{2}^{t} , and {w}_{3}^{t}$$

represent values of the first buoy w₁, second buoy w₂, and third buoy w₃ generated last time, and let

$${w}_{1}^{t + 1} , {w}_{2}^{t + 1} , and {w}_{3}^{t + 1}$$

represent values of the first buoy w₁, second buoy w₂, and third buoy w₃ currently generated. The values generated last time must satisfy the relationship

$${w}_{1}^{t} \leq {w}_{2}^{t} \leq {w}_{3}^{t} ;$$

firstly, assign a smaller one of

$${w}_{2}^{t + 1} and {w}_{3}^{t + 1}$$

as being the

$${w}_{2}^{t + 1} ,$$

and the larger one of

$${w}_{2}^{t + 1} and {w}_{3}^{t + 1}$$

as being the

$${w}_{3}^{t + 1} .$$

after this operation,

$${w}_{2}^{t + 1} and {w}_{3}^{t + 1}$$

will satisfy the relationship

$${w}_{2}^{t + 1} \leq {w}_{3}^{t + 1} .$$

If

$${w}_{1}^{t + 1} > {w}_{3}^{t + 1} ,$$

assign the larger one of

$${w}_{1}^{t + 1} and {w}_{3}^{t}$$

as being the

$${w}_{2}^{t + 1} and the {w}_{3}^{t + 1} .$$

After this operation,

$${w}_{1}^{t + 1} , {w}_{2}^{t + 1} , and {w}_{3}^{t + 1}$$

satisfy the relationship

$${w}_{1}^{t + 1} \leq {w}_{2}^{t + 1} \leq {w}_{3}^{t + 1} ,$$

and the logic ends. If

$${w}_{1}^{t + 1} > {w}_{2}^{t + 1} ,$$

assign the larger one of

$${w}_{1}^{t + 1} and {w}_{2}^{t}$$

as being the

$${w}_{2}^{t + 1} .$$

After this operation,

$${w}_{1}^{t + 1} , {w}_{2}^{t + 1} , and {w}_{3}^{t + 1}$$

satisfy the relationship

$${w}_{1}^{t + 1} \leq {w}_{2}^{t + 1} \leq {w}_{3}^{t + 1} ,$$

and the logic ends.

After the logic is executed,

$${w}_{1}^{t + 1} , {w}_{2}^{t + 1} , and {w}_{3}^{t + 1}$$

will definitely satisfy the relationship

$${w}_{1}^{t + 1} \leq {w}_{2}^{t + 1} \leq {w}_{3}^{t + 1} .$$

At this point, subsequent operations can continue according to operation logics based on the relative sizes of the three buoy values being in the normal circumstances.

After generating new values for the three buoys, the Coordinator needs to adjust the states of the Pods so that the number of Pod replicas in each Pod state matches the corresponding buoy value(s). The specific adjustment logic is as follows:

If

$${w}_{3}^{t + 1} \geq {w}_{3}^{t} ,$$

first create

$${w}_{3}^{t + 1} - {w}_{3}^{t}$$

number of Pods. If

$${w}_{3}^{t + 1} < {w}_{3}^{t} ,$$

delete

$${w}_{3}^{t} - {w}_{3}^{t + 1}$$

number of Pods. Pods to be deleted are performed according to the following priority in terms of the Pod states: Initializing>Warming-up>L2-Suspended>L1-Suspended>Running.

Then, prioritize adjustment of a number of Pods in Running state to

$${w}_{1}^{t + 1} .$$

When the number of Pods in Running state needs to be increased, Pods in other states are used to be converted to the Running state according to the following priority in terms of Pod states: L1-Suspended>L2-Suspended>Warming-up. When the number of Pods in Running state needs to be reduced, directly convert the excess number of Pods in Running state to L1-Suspended state.

After the number of Pods in Running state matches the number of

$${w}_{1}^{t + 1} ,$$

begin adjusting the number of Pods in L1-Suspended state to

$${w}_{2}^{t + 1} .$$

When the number of Pods in L1-Suspended state needs to be increased, Pods in other states are used to be converted to the L1-Suspended state according to the following priority in terms of Pod states: L2-Suspended>Warming-up. When the number of Pods in L1-Suspended state needs to be reduced, convert the excess number of Pods in L1-Suspended state to L2-Suspended state.

Furthermore, the Pods resource management operations refer to the Pod resource manager modifying attributes of the Pods such as available CPU and memory resources based on state changes of the Pods in the machine cluster of the present invention. Details of the expected outcomes after state change of the Pods are as follows:
Initializing→Warming-up: No operation of the Pod resource manager.
Warming-up→Running: No operation of the Pod resource manager.
Running→L1-Suspended: The Pod resource manager reduces Pod's available CPU resources.
L1-Suspended→L2-Suspended: The Pod resource manager reduces Pod's available memory resources.
L2-Suspended→L1-Suspended: The Pod resource manager increases Pod's available memory resources to its originally limited value.
L1-Suspended→Running: The Pod resource manager increases Pod's available CPU resources to its originally limited value.

Since consecutive state jumps are allowed within one control cycle, situations may occur where a Pod may seem to transition directly from Running to L2-Suspended. In this case, the Pod resource manager must simultaneously perform both CPU and memory resources reduction operations on the corresponding Pod.

In this embodiment, in terms of CPU resources control, the Pod resource manager collects statistics of each Pod in relation to a total time, consisting of the corresponding Pod's CPU usage time and a time of Pod's requests to CPU that were not responded and fulfilled, within a predetermined period. The resource management system refers to this total time as “CPU duration.” A detailed logic for adjusting the corresponding Pod's resources is as follows:

If a Pod remains in the Running state, set its CPU duration limit to the maximum CPU duration observed within a time window. However, if this value exceeds the Pod's configured maximum available CPU duration, use the Pod's configured maximum available CPU duration instead.

If a Pod transitions from Running state to L1-Suspended state or L2-Suspended state, set its CPU duration limit to (1+γ) times the average CPU duration within the time window. γ is a hyperparameter that can be adjusted as needed, with a default value of 0.5. A higher value of γ may better ensure service quality but consume more resources.

If a Pod transitions directly from L1-Suspended state or L2-Suspended state to Running state, set its resources to the maximum available CPU resources of all Pods in the same microservice.

If the number of Pods in Running state decreases during this control cycle (from number p to number q), set all Pods' CPU duration limits to the larger one of the current CPU duration limit and p/q times the CPU duration from the previous time period.

Additionally, set each of all Pods' burst CPU duration usage to a value of Pod's configured maximum available CPU duration minus the current Pod's CPU duration limit.

In this embodiment, a Pod's CPU duration limit is implemented by adjusting the cpu.cfs_quota_us field in Linux cgroups, and the burst CPU duration limit is implemented by adjusting the cpu.cfs_burst_us field in Linux cgroups.

In this embodiment, in terms of memory resources control, the Pod resource manager counts a number of page faults for each Pod over a predetermined period of time, and uses h number of page faults as a threshold (preferably h=1024) to self-adaptively allocate available memory resources to Pods in L2-Suspended state. Specifically, the Pod resource manager adjusts a Pod's available memory size using the following strategy:

For a Pod entering the L2-Suspended state for the first time, set its available memory resources to r MB (preferably r=10).

For a Pod already in the L2-Suspended state, if its average page faults over the predetermined period of time exceed the number h, increase its memory resources by r MB.

For a Pod leaving the L2-Suspended state for the first time, set its available memory resources to an originally defined maximum memory usage and invoke the specific system call to swap in all memory pages still on the disk back into memory.

In this embodiment, a Pod's available memory resources are implemented by adjusting the memory.high field in Linux cgroups.

During implementation, steps S4 to S6 are executed cyclically. Each control cycle involves generating new buoy values, adjusting Pod states, and adjusting each Pod's resources. The three buoys (w₁, w₂, and w₃) are updated at different frequencies. If a buoy value is not updated during a control cycle, a corresponding buoy value from the previous cycle is used for the current buoy value in the current cycle.

Clearly, the above embodiments of the present invention are merely illustrative examples used to clearly explain the technical solutions of the invention and should not be construed as limiting the specific implementations of the invention. Any modifications, equivalent substitutions, or improvements made within the essence and principle of the present invention shall be included within the scope of the claims.

What is claimed is:

1. A resource management system for a stateless microservice architecture, applicable to a machine cluster running a Linux operating system and a Kubernetes container orchestration platform; the resource management system comprises:
a Linux kernel, installed on the machine cluster, for specific system calls;
a Microservice Resource Manager for each microservice, installed on a control node of the machine cluster, equipped with a plurality of sub-managers driven to generate buoys indicating a number of Pod replicas in corresponding states based on statistical data;
a Coordinator for each said microservice, installed on the control node of the machine cluster, for controlling state transitions, creation, and deletion of Pods for a corresponding microservice based on the buoys generated by the plurality of sub-managers; and
a Pod Resource Manager, installed on each compute node of the machine cluster, for monitoring state changes of the Pods and executing corresponding Pods resource management operations.

2. The resource management system of claim 1, wherein the plurality of sub-managers of the Microservice Resource Manager comprises: a Responsive Sub-manager, a Short-term Predictive Sub-manager, and a Long-term Predictive Sub-manager;
the Responsive Sub-manager generates an initial value of a first buoy w₁ using responsive methods based on the corresponding microservice's past resource usage within a predetermined period;
the Short-term Predictive Sub-manager uses EnbPI interval prediction and SVR single-step prediction algorithms for short-term forecasting to generate an initial value of a second buoy w₂;
the Long-term Predictive Sub-manager uses Prophet periodic prediction, the EnbPI interval prediction, and the SVR single-step prediction algorithms for long-term forecasting to generate an initial value of a third buoy w₃.

3. The resource management system of claim 2, wherein each of the Pods is capable of running in either one of the following states: Initializing state, Warming-up state, Running state, L1-Suspended state, and L2-Suspended state;
the Initializing state refers to a state where initialization is performed on a corresponding Pod which is newly created; the Pods in said Initializing state are unable to provide any microservice computation;
the Warming-up state refers to a state where a corresponding Pod has completed initialization and is able to provide said microservice computation but yet to reach a peak execution speed and a peak response time;
the Running state refers to a state where a corresponding Pod normally process requests at the peak execution speed and the peak response time;
the L1-Suspended state refers to a state where a corresponding Pod has CPU resources thereof partially or entirely reclaimed, and does not accept new load requests;
the L2-Suspended state refers to a state where on a basis of the corresponding Pod in said L1-Suspended state, the corresponding Pod also has memory resources thereof partially reclaimed;
the First buoy w₁ represents a number of Pods in the Running state in the corresponding microservice;
the Second buoy w₂ represents a sum of the number of Pods in the Running state and in the L1-Suspended state in the corresponding microservice;
the Third buoy w₃ represents a total number of Pods across all states in the corresponding microservice.

4. The resource management system of claim 3, wherein the Coordinator determines whether to perform buoy value repair operations based on relative sizes of the initial value of the first buoy w₁, the initial value of the second buoy w₂, and the initial value of the third buoy w₃, as follows:
under normal circumstances, the relative sizes of three initial values of the first buoy w₁, the second buoy w₂, and the third buoy w₃ satisfy w₁≤w₂≤w₃;
under abnormal circumstances, when the relative sizes of the three initial values do not satisfy w₁≤w₂w₃, the Coordinator corrects the values of the first buoy w₁, the second buoy w₂, and the third buoy w₃ to satisfy a normal relative size relationship;
and given that w₁≤w₂≤w₃ is satisfied, the Coordinator adjusts the states of the corresponding Pods according to a state transition logic, hence ensuring that a number of Pod replicas of each Pod state matches resulting corresponding corrected buoy value(s);
the Coordinator correct the values of the first buoy w₁, the second buoy w₂, and the third buoy w₃ to satisfy the normal relative size relationship according to the following logic:
let
$${w}_{1}^{t} , {w}_{2}^{t} , and {w}_{3}^{t}$$
represent values of the first buoy w₁, the second buoy w₂, and the third buoy w₃ generated last time respectively, and let
$${w}_{1}^{t + 1} , {w}_{2}^{t + 1} , and {w}_{3}^{t + 1}$$
represent values of the first buoy w₁, the second buoy w₂, and the third buoy w₃ currently generated respectively; wherein the values generated last time satisfy a relationship
$${w}_{1}^{t} \leq {w}_{2}^{t} \leq {w}_{3}^{t} ;$$
firstly, assign a smaller one of
$${w}_{2}^{t + 1} and {w}_{3}^{t + 1}$$
as being a corrected
$${w}_{2}^{t + 1} ,$$
and a larger one of
$${w}_{2}^{t + 1} and {w}_{3}^{t + 1}$$
as being a corrected
$${w}_{3}^{t + 1} ;$$
after this correction operation, corrected
$${w}_{2}^{t + 1} and {w}_{3}^{t + 1}$$
satisfy a relationship
$${w}_{2}^{t + 1} \leq {w}_{3}^{t + 1} ;$$
and then, if
$${w}_{1}^{t + 1} > {w}_{3}^{t + 1} ,$$
assign the larger one of
$${w}_{1}^{t + 1} and {w}_{3}^{t}$$
as being a corrected
$${w}_{2}^{t + 1}$$
and a corrected
$${w}_{3}^{t + 1} ;$$
after this correction operation,
$${w}_{1}^{t + 1} , {w}_{2}^{t + 1} , and {w}_{3}^{t + 1}$$
after corrections above satisfy a relationship
$${w}_{1}^{t + 1} \leq {w}_{2}^{t + 1} \leq {w}_{3}^{t + 1} ,$$
and the logic ends; if
$${w}_{1}^{t + 1} > {w}_{2}^{t + 1}$$
assign a larger one of
$${w}_{1}^{t + 1} and {w}_{2}^{t}$$
as being a corrected
$${w}_{2}^{t + 1} ;$$
after this correction operation,
$${w}_{1}^{t + 1} , {w}_{2}^{t + 1} , and {w}_{3}^{t + 1}$$
after correction satisfy the relationship
$${w}_{1}^{t + 1} \leq {w}_{2}^{t + 1} \leq {w}_{3}^{t + 1} ,$$
and the logic ends; after the logic is executed,
$${w}_{1}^{t + 1} , {w}_{2}^{t + 1} , and {w}_{3}^{t + 1}$$
satisfy the relationship
$${w}_{1}^{t + 1} \leq {w}_{2}^{t + 1} \leq {w}_{3}^{t + 1} ,$$
and then subsequent operations continue according to operation logics based on the relative sizes of three buoy values being in the normal circumstances.

5. The resource management system of claim 4, wherein the Coordinator adjusts the states of the corresponding Pods according to the state transition logic, hence ensuring that the number of Pod replicas of each Pod state matches resulting corresponding corrected buoy value(s); wherein the state transition logic to adjust the states of the corresponding Pods is as follows:
if
$${w}_{3}^{t + 1} \geq {w}_{3}^{t} ,$$
first create
$${w}_{3}^{t + 1} - {w}_{3}^{t}$$
number of Pods; if
$${w}_{3}^{t + 1} < {w}_{3}^{t} ,$$
first delete
$${w}_{3}^{t} - {w}_{3}^{t +}$$
number of Pods; pods to be deleted are performed according to the following priority in terms of the Pod states: Initializing state>Warming-up state>L2-Suspended state>L1-Suspended state>Running state;
then prioritize adjustment of a number of Pods in Running state to
$${w}_{1}^{t + 1} ;$$
when the number of Pods in Running state needs to be increased, Pods in other states are used to be converted to the Running state according to the following priority in terms of Pod states: L1-Suspended state>L2-Suspended state>Warming-up state; when the number of Pods in Running state needs to be reduced, directly convert excess number of Pods in Running state to L1-Suspended state;
after the number of Pods in Running state matches a number represented by
$${w}_{1}^{t + 1} ,$$
begin adjusting the number of Pods in L1-Suspended state to
$${w}_{2}^{t + 1} ;$$
when the number of Pods in L1-Suspended state needs to be increased, Pods in other states are used to be converted to the L1-Suspended state according to the following priority in terms of Pod states: L2-Suspended state>Warming-up state; when the number of Pods in L1-Suspended state needs to be reduced, convert excess number of Pods in L1-Suspended state to L2-Suspended state.

6. The resource management system of claim 3, wherein the Pod resource manager control resources of a corresponding Pod according to the following logics:
in terms of CPU resources control, the Pod resource manager collects statistics of each of the Pods in relation to a total time, consisting of the corresponding Pod's CPU usage time and a time of Pod's requests to CPU that were not responded and fulfilled, within a predetermined period; said total time is referred to as CPU duration; a detailed logic for adjusting the resources of the corresponding Pod is as follows:
if a Pod remains in the Running state, set a CPU duration limit of the Pod to a maximum CPU duration observed within a time window; if this maximum CPU duration exceeds the Pod's configured maximum available CPU duration, use the Pod's configured maximum available CPU duration instead;
if a Pod transitions from the Running state to the L1-Suspended state or the L2-Suspended state, set the CPU duration limit of the Pod to (1+γ) times an average CPU duration within the time window, wherein γ is a hyperparameter;
if a Pod transitions directly from the L1-Suspended state or the L2-Suspended state to the Running state, set resources of the Pod to maximum available CPU resources of all Pods in a same microservice;
if the number of Pods in the Running state decreases during a control cycle from number p to number q, set all Pods' CPU duration limits to a larger one of a current CPU duration limit and p/q times the CPU duration from a previous time period;
set each of all Pods' burst CPU duration usage to a value of the Pod's configured maximum available CPU duration minus the current Pod's CPU duration limit;
and/or
in terms of memory resources control, the Pod resource manager counts a number of page faults for each of the Pods over a predetermined period of time, and uses h number of page faults as a threshold to self-adaptively allocate available memory resources to Pods in the L2-Suspended state; the Pod resource manager adjusts a Pod's available memory size using the following strategy:
for a Pod entering the L2-Suspended state for the first time, set available memory resources of that Pod to r MB;
for a Pod already in the L2-Suspended state, if a number of average page faults of that Pod over the predetermined period of time exceed the number h, increase memory resources of that Pod by r MB;
for a Pod leaving the L2-Suspended state for the first time, set available memory resources of that Pod to an originally defined maximum memory usage and invoke a specific system call to swap in all memory pages still on a disk back into a memory.

7. The resource management system of claim 3, wherein the Responsive Sub-manager and the Short-term Predictive Sub-manager generate the first buoy w₁ and the second buoy w₂ respectively as follows:
a proportional relationship between a buoy value from a previous time period and a current statistical data is used to determine a current buoy value, mathematically described as:
$${w}_{x}^{t + 1} = ⌈ {w}_{x}^{t} * \frac{{M}_{current}}{{M}_{standard}} ⌉ ; \qquad ( 1 )$$
in the above formula (1), wₓ represents either the first buoy w₁ or the second buoy w₂;
$${w}_{x}^{t}$$
represents a value of buoy wₓ at time t;
$${w}_{x}^{t + 1}$$
represents a value of the buoy wₓ at time t+1; M_{current} represents a current value of a certain metric M; M_{standard} represents an ideal value of the metric M;
wherein, M_{current} has a negative correlation with wₓ, meaning that if other variables are unchanged, a larger wₓ results in a smaller M_{current}; if the metric in concern does not have this negative correlation, mathematical transformations is applied to satisfy this negative correlation;
M_{standard} is a predetermined value, and the metric M is a Pod related metric;
different metrics M are used by the Responsive Sub-manager and the Short-term Predictive Sub-manager respectively;
the Responsive Sub-manager calculates one of different sources of M_{standard} by taking an average of metric changes within a sliding time window and adding a product of a percentile threshold a and a standard deviation, as shown in formula (2):
$${n}_{1} = mean ( {H}_{M}^{m} ) + PPF ( {H}_{M}^{m} , 0.95 ) * stdev ( {H}_{M}^{m} ) ; \qquad ( 2 )$$
in formula (2),
$$mean ( {H}_{M}^{m} )$$
represents an average of metric sequence M within a time window of size m;
$$PPF ( {H}_{M}^{m} , a )$$
represents a percentile threshold of the metric sequence M within the time window of size m;
$$stdev ( {H}_{M}^{m} )$$
represents the standard deviation of the metric sequence M within the time window of size m;
v₁ is one important source for the Responsive Sub-manager to generate
$${M}_{current} ; \qquad ( 3 )$$
$${v}_{2} = max ( {H}_{M}^{n} ) ;$$
$$max ( {H}_{M}^{n} )$$
in formula (3) represents a maximum value of the metric sequence M within a time window of size n, and v₂ is another important source for the Responsive Sub-manager to generate M_{current};
$${M}_{current} = max ( {v}_{1} , {v}_{2} ) ; \qquad ( 4 )$$
the Responsive Sub-manager's M_{current} is obtained from formulas (2), (3), and (4); by substituting a calculated M_{current} into formula (1), a corresponding buoy value
$${w}_{x}^{t + 1}$$
for a corresponding microservice at the next time point t+1 is obtained.

8. The resource management system of claim 7, wherein the Short-term Predictive Sub-manager uses the SVR single-step prediction algorithm as an underlying regression algorithm for single-step prediction and then uses the EnbPI interval prediction algorithm for interval prediction; the Short-term Predictive Sub-manager continuously collects V+N observed metrics from a past period as a new set of training data for the SVR, wherein the V observed metrics form input values of the training data, and a maximum value of the N observed metrics serves as a label value for that set of training data, and this set of data is added to the training data; when a number of training data sets meets a minimum requirement for training sets, an SVR prediction group is obtained in two ways:
1. when collected training data sets first meet training requirements, train B new SVR models based on the collected training data sets to obtain an initial SVR prediction group;
2. when an SVR prediction group already exists, delete the oldest set of training data and k number of SVR predictors trained with the oldest data in the EnbPI interval prediction algorithm, then, train k number of new SVR predictors based on the new set of training data to keep a number of predictors in the SVR prediction group constant at a number B;
according to an execution method of the EnbPI interval prediction algorithm, a confidence level a is set; using an existing SVR prediction group, a maximum value y within next N observed metrics is predicted based on the most recent V observed metrics, and ensuring that a probability of a true maximum not exceeding a predicted maximum value y is
$$\frac{1 + α}{2} ;$$
the Short-term Predictive Sub-manager uses the maximum value y predicted by the above EnbPI interval prediction and SVR single-step prediction algorithms as M_{current}, and substitutes this value of the M_{current} into formula (1) to obtain a value of the second buoy w₂.

9. The resource management system of claim 8, wherein the Long-term Predictive Sub-manager first uses the Prophet algorithm to directly predict a number of Pod replicas required at a next time point based on historical cycle changes of request loads, and thus an initial value of the third buoy w₃ is obtained;
if a value of the third buoy w₃ generated by the Long-term Predictive Sub-manager is less than a value of the second buoy w₂ generated by the Short-term Predictive Sub-manager, the value of the third buoy w₃ is corrected.

10. The resource management system of claim 9, wherein the value of the third buoy w₃ is corrected by combined use of EnbPI interval prediction and SVR single-step prediction method; wherein, a confidence level β is set to predict a difference z between the second buoy w₂ and an initial third buoy w₃; the initial third buoy w₃ plus a predicted value z serves as an initial value of a new corrected third buoy w₃.
